(19) United States
(12) Patent Application Publication
(10) Pub. No.: US 2010/0199920 A1
(43) Pub. Date: Aug. 12, 2010

(54) BIRD PERCH AND WASTE CONTAINMENT

(76) Inventor: MATTHEW SCOTT ROTHGERY, PRESCOTT VALLEY, AZ (US)

Correspondence Address: MATTHEW SCOTT ROTHGERY, 3338 PADDY LANE, LOVELAND, CO, 80537, US

(21) Appl. No.: 12/685,601

(22) Filed: Jan. 28, 2010

Related U.S. Application Data
(60) Provisional application No. 61/145,784, filed on Jan. 20, 2009.

(51) Int. Cl. A01K 31/12; A01K 29/00

(52) U.S. Cl. 119/537; 119/161

(57) ABSTRACT

A decorative, functional perch system for pet birds, which maximizes climbing/perching areas for a bird while minimizing opportunities for said climbing/perching areas to accumulate droppings. Said system also minimizes the visual profile of the waste containment means.

### BACKGROUND OF THE INVENTION

The present invention pertains to the endeavor to create a decorative and useful portable perch and recreation stand for pet birds.

Pet bird playstands and perches are commonly manufactured for market. A simple perch is useful for interacting with a pet bird at eye level and may have a single horizontal branch and a horizontal pan or tray below to contain waste. More complex perches, which may be referred to as ‘playstands’, are useful also for providing recreation, and may have many branches. However, these branches tend to accumulate droppings from the bird perched on branches above. Also, the more branches there are, the larger is the footprint that requires waste containment below, thus reducing portability.

Traditional means for waste containment consists of a durable solid surface that is oriented horizontally. This orientation allows for viewing of unpleasant waste material from any viewpoint and commonly allows the pet bird to walk on this surface resulting in waste material being disturbed.

Examining the functionality of these products available today gives cause to the endeavor of the present invention. One objective of the endeavor is to maximize the amount of climbing and perching surface areas for a bird while minimizing opportunities for these surfaces to accumulate bird droppings. Another objective of the endeavor is to minimize the visual profile of the waste containment means while also minimizing the field of view of the waste itself. Still another objective is to provide waste containment means wherein a bird has minimized interest in traversing the surface where waste material is contained.

### BRIEF SUMMARY OF THE INVENTION

The objectives of the present invention are met by combining two technologies; claims 1 and 2 describe similar Perch Systems, while claims 3 and 4 describe means of Waste Containment. Both technologies are independent, meaning they can stand alone or be combined with other technologies.

### BRIEF DESCRIPTION OF THE DRAWINGS

FIG. 1 is a perspective view of the Perch System as described in claim 1 with Waste Containment

FIG. 2 is a side elevation view of the Perch System as described in claim 1 with Waste Containment

FIG. 3 is a front elevation view of the Perch System as described in claim 1 with Waste Containment

FIG. 4 is a perspective view of the Perch System as described in claim 2 with Waste Containment in varied positions.

FIG. 5 shows alternative Waste Containment surfaces conforming to the cross sectional profile as described in claim 3

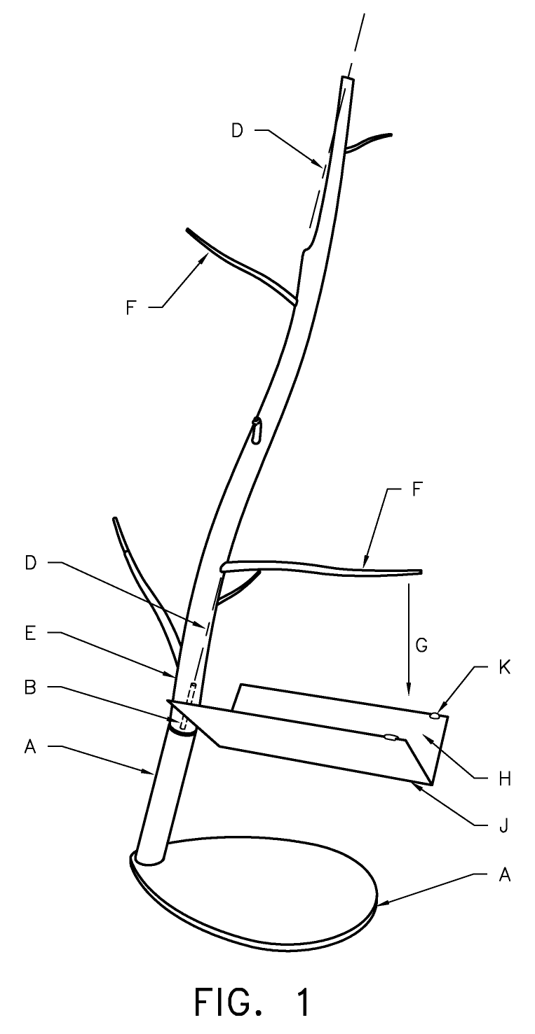

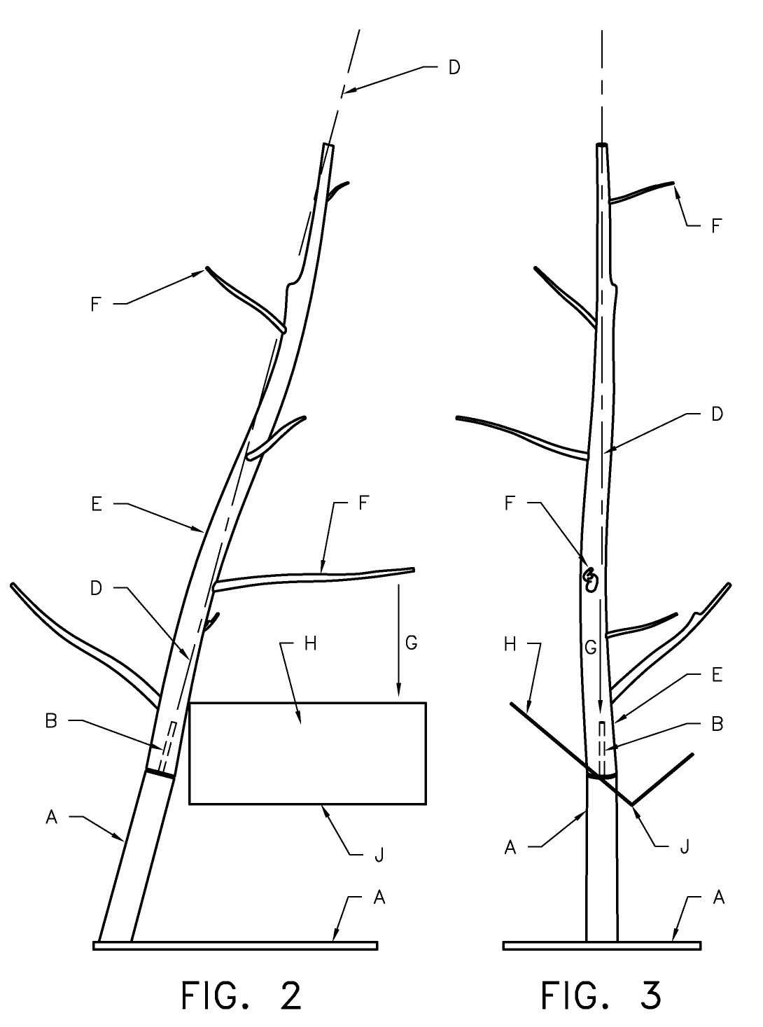

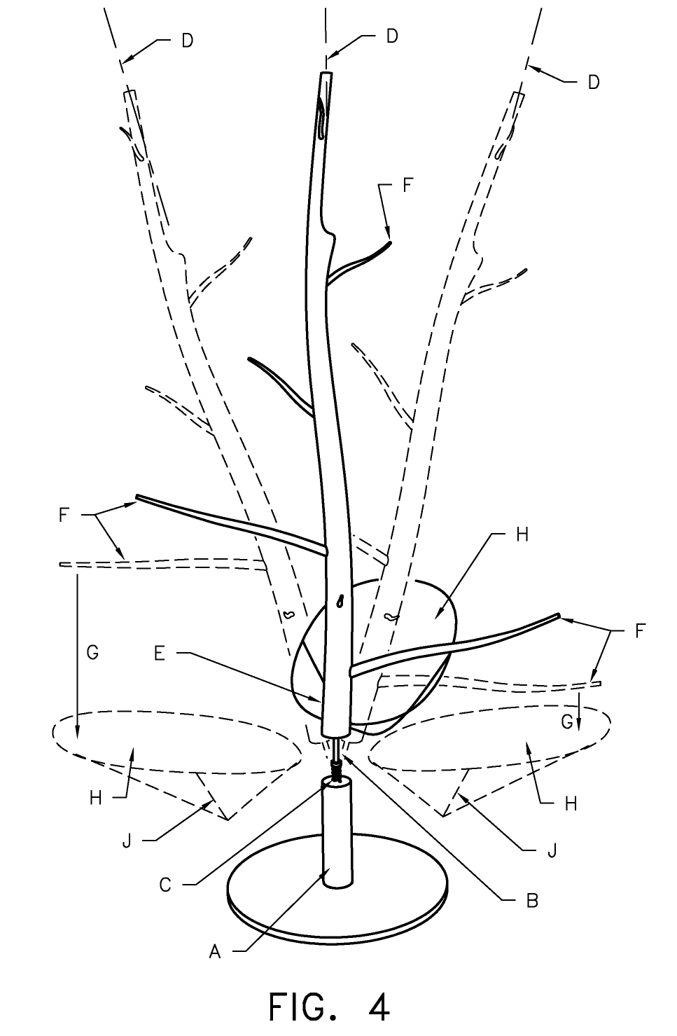

### DESCRIPTIONS FOR LETTER REFERENCES IN ALL DRAWINGS ARE CONSISTENT

(A) Designates the base
(B) Designates the pivoting means
(C) Designates means of flexure
(D) Designates the axis of rotation
(E) Designates the main branch
(F) Designates a typical secondary branch
(G) Designates the gravitational vector
(H) Designates the waste containment surface
(J) Designates the primary crease
(K) Designates means of fastening a lining material

### DETAILED DESCRIPTION OF THE INVENTION

No claim is made regarding the process of manufacturing the present invention or the materials used. The elements that distinguish the present invention from prior art are what is claimed regardless of their material composition or fabrication method. Referring to the present invention as depicted in the drawings:

The base (A) is preferably a decorative wooden board substantially centered below the center of gravity of the perch system (E)(F). The base may also be a mass with a smaller perimeter but with enough weight to prevent the perch system from overturning. Or the base can be a permanent foundation.

Regardless of what the base is, the base is that to which pivoting means (B) is affixed. Pivoting means preferably is a ½ inch steel rod protruding from the base approximately 5½ inches with a smooth flat top upon which the weight of the perch system (E)(F) above bears. But there are many other ways, such as a thrust bearing, to implement the claimed pivoting means (B).

The main branch (E) as depicted in the drawing is preferably a branch of dried wood extending approximately 5 feet and has a ½ inch hole in the lower end. The hole being shallower than the protruding length of the steel rod allows the main branch to rotate freely on the rod. It should be noted that the main branch need not be concentric with the axis of rotation (D). In fact, what is called the main branch may itself branch into separate trunks. Whatever the geometry of the main branch, it is that component which is rotatably attached to the pivoting means.

The axis of rotation (D) is chosen to be less than vertical so that the weight of a bird will cause the perch system (E)(F) to rotate. If the inclination of the axis of rotation (D) is too far from vertical, the geometry of the perch system is limited; therefore 75% to 95% inclination is preferable.

Secondary branches (F) are fastened to the main branch such that the weight of all the branches including the main branch is substantially balanced about the axis of rotation (D). Also, the branches (E)(F) are arranged such that when a bird is perched and gravity (G) causes the perch system to rotate, the bird will not be positioned above another branch but will be in a position directly above the waste containment surface (H). It should be noted that although it is preferable to make each instance of the present invention unique by assembling the perch system according to the random geometry found in natural wood materials and allowing for artistic expression, the perch system may be fabricated of predesigned components of any material.

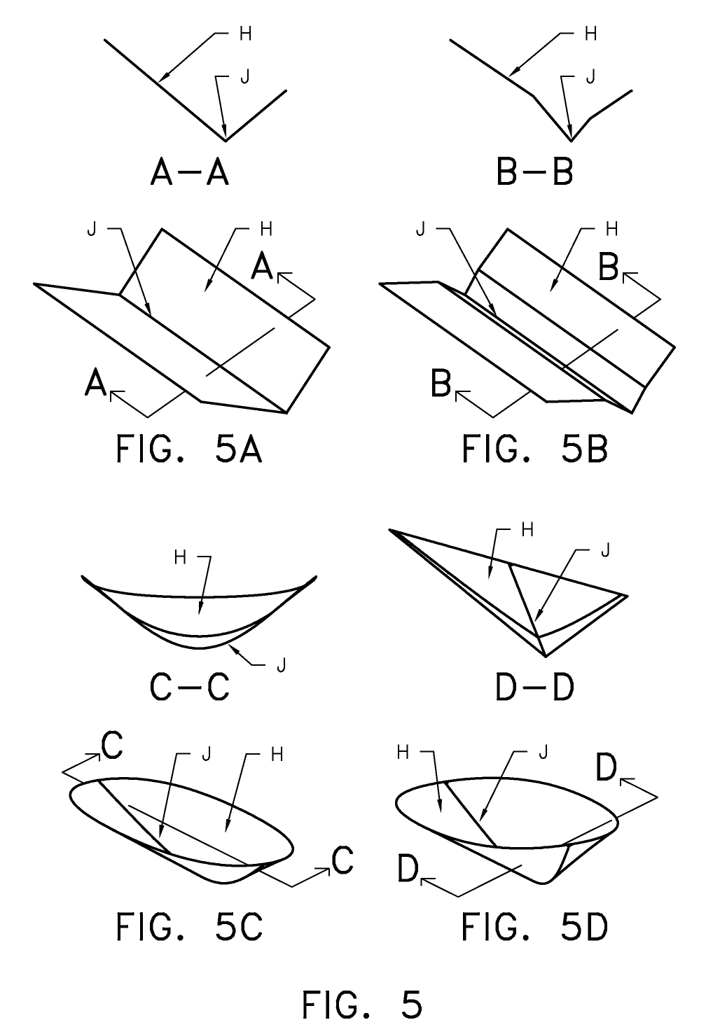

The waste containment surface (H) is preferably composed of a coated wire mesh screen bounded by an aluminum frame, which is then bent to the profile shown in FIG. 5A. The configuration of this bent surface directs waste material to the primary crease (J) and allows the waste to be hidden from view when the viewer stands far away, approximately 10 feet. Also the sloping sides discourage a bird from traversing the surface and disturbing the waste material.

A paper liner is preferably placed over the surface for convenient waste disposal and any means to fasten the liner in place (K) may or may not be provided; both methods are claimed. No claim is made about the necessity for a lining material; for example, the surface can be made of a durable solid surface that is easily rinsed clean. Substantial compliance to the described cross sectional profile is what is claimed.

The basic cross sectional profile shown in FIG. 5A may be improved as shown in FIG. 5B by creating slightly steeper slopes near the primary crease (J) so as to further discourage birds from traversing the surface and for improved appearance. However this alternative shape is in substantial compliance to the basic cross sectional profile as claimed.

Because a paper liner conforms better to a surface that is curved in only one direction, the cross sectional profile is applied in one direction for surface that requires a liner. But in case a solid surface is chosen and a liner is omitted, the cross sectional profile may be applied in various directions or swept around the perimeter to form the waste containment surface. Any substantial application of the described cross sectional profile is what is claimed.

FIG. 4 shows the perch system as described in claim 2. It varies from the perch system as described in claim 1 because it does not rotate on the base (A), rather it tilts slightly in all directions by means of flexure (C) which is preferably implemented with a medium duty steel compression spring. Pivoting means (B) is preferably a ½ inch steel rod with a lower shoulder upon which the weight of the waste containment bears and is allowed to rotate freely. Also, pivoting means (B) is preferably affixed to the means of flexure (C) below and affixed to the perch system (E)(F) above while allowing the waste containment to rotate freely. The pivoting means described in this claim may be situated anywhere along the lower extremity of the main branch (E). However or wherever the pivoting means is implemented, it establishes an axis of rotation (D) about which the weight of the perch system must be substantially balanced. In this case, the weight of a bird causes the perch system and axis of rotation (D) to tilt, the waste containment will rotate to a position directly below the bird thereby satisfying the smallest possible waste containment surface for a given perch system.

1. A perch system for pet birds comprised of a base and pivoting means affixed thereto;
said pivoting means establishing an axis of rotation angled slightly less than vertical, upon which a main branch is allowed to rotate freely;
upon said main branch being affixed secondary branches, which are substantially arranged such that any point on a secondary branch is not oriented above another branch when the gravitational vector from said point is in a plane with said axis of rotation;
the weight of said system being substantially balanced about said axis of rotation.

2. A perch system for pet birds comprised of a base and means of flexure affixed thereto;
upon said means of flexure a main branch is allowed to tilt slightly in all directions without rotating;
upon the lower extremities of said main branch being affixed pivoting means establishing an axis of rotation which is aligned vertically when the perch system is unweighted;
upon said axis of rotation a waste containment means is allowed to rotate freely;
upon said main branch being affixed secondary branches, which are substantially arranged such that any point on a secondary branch is not oriented above another branch when the gravitational vector from said point is in a plane with said axis of rotation;
the weight of said system being substantially balanced about said axis of rotation.

3. Waste containment means comprised of a surface having a cross sectional profile which conforms substantially to the description:
an apex from which originates a primary line extending upward and away from said apex at an approximate slope of 1:1 and a secondary line extending upward and away from said apex opposite the primary line at an approximate slope of 1:1, the ratio of the lengths of said primary and secondary lines being approximately 2:1;
said apex forming the primary crease of said surface which is substantially oriented horizontally;
and said surface having bounding edges substantially enveloping points of waste production.

4. The waste containment means as described in claim 2 with means to fasten a lining material for removal of waste material.
